(19) United States
(12) Patent Application Publication
(10) Pub. No.: US 2020/0005410 A1
(43) Pub. Date: Jan. 2, 2020

(54) System and Method for Facilitating Legal Review for Commercial Loan Transactions

(71) Applicant: Peter Kingsley McKee, Dallas, TX (US)

(72) Inventor: Peter Kingsley McKee, Dallas, TX (US)

(21) Appl. No.: 16/452,510

(22) Filed: Jun. 25, 2019

Related U.S. Application Data
(60) Provisional application No. 62/692,634, filed on Jun. 29, 2018.

(51) Int. Cl. G06Q 50/16; G06F 16/22; G06Q 40/04

(52) U.S. Cl. CPC G06Q 50/163; G06Q 40/04; G06F 16/22

(57) ABSTRACT

A computerized method is disclosed for recording information associated with a commercial real estate asset that would facilitate legal review for future transactions. The method includes providing a legal data record template for receiving information related to the commercial real estate asset, storing the legal data record information in a database, setting access rules for accessing the legal data record information, creating a blockchain record of legal information that contains the legal data record information from the database, adding the blockchain record of legal information to a blockchain for the commercial real estate asset, and maintaining the blockchain for the commercial real estate asset. Using blockchain technology facilitates the creation of a network of users that are inter-connected with access to the blockchain records of legal information for any commercial real estate asset included within the users' blockchains.

### RELATED APPLICATION

This non-provisional patent applications claims the benefit of U.S. Provisional Application No. 62/692,634 filed on Jun. 29, 2018, incorporated herein by reference.

### FIELD

The present disclosure relates to the field of blockchain technology and artificial intelligence, and in particular to using blockchain technology to store data associated with legal review and expert-curated analysis of commercial real estate assets, specifically including those assets that are part of a commercial mortgage-backed securities loan transaction.

### BACKGROUND

Bitcoin is a crypto currency which is transacted on a secure decentralized ledger that is distributed throughout its open network. The ledger is known as the blockchain and it allows participants in the network to transact bitcoin without the need for a trusted third party, such as a bank. Separately, it also prevents double spending, stealing, and the forging of value.

### BRIEF DESCRIPTION OF THE DRAWINGS

FIG. 1 is a simplified flowchart of an exemplary embodiment of a process for facilitating legal review for a commercial mortgage-backed security transaction according to the teachings of the present disclosure;

FIG. 2 is a simplified block diagram of a blockchain according to the teachings of the present disclosure; and

FIG. 3 is a simplified block diagram of an exemplary embodiment of a system for facilitating legal review for a commercial mortgage-backed security transaction according to the teachings of the present disclosure.

### DETAILED DESCRIPTION

The financial services industry, beyond looking at the potential of crypto currencies, has recently turned its attention to using the blockchain ledger separate from bitcoin or other crypto currencies and applying it to other processes and products. The blockchain is a data structure that stores a list of transactions, forming a distributed electronic ledger that records transactions between source identifiers and destination identifiers. The transactions are bundled into blocks and every block (except for the first block) refers back to or is linked to a prior block in the chain. Computer nodes maintain the blockchain and crypto-graphically validate each new block and the transactions contained therein. The integrity (e.g., confidence that a previously recorded transaction has not been modified) of the entire blockchain is maintained because each block refers to or includes a cryptographic hash value of the prior block. Accordingly, once a block refers to a prior block, it becomes difficult to modify or tamper with the data (e.g., the transactions) contained therein. This is because even a small modification to the data will affect the hash value of the entire block. Each additional block increases the difficulty of tampering with the contents of an earlier block. Thus, even though the contents of a blockchain may be available for all to see, they become practically immutable.

The attraction of the blockchain process is significant. It offers a low-cost distributed-transaction record solution. The near-real time speed of the transactions, the ease of transacting between parties and the nature of the technology also offer the potential of wholly new business models and practices. This allows the participants to verify and audit transactions inexpensively without the necessity of validating intermediaries. A blockchain database is managed autonomously using a peer-to-peer network and a distributed timestamping server. They are authenticated by mass collaboration powered by collective self-interests. The result is a robust workflow where participants' uncertainty regarding data security is marginal. The use of a blockchain removes the characteristic of infinite reproducibility from a digital asset. It confirms that each unit of value was transferred only once, solving the long-standing problem of double spending. Blockchains have been described as a value-exchange protocol. This blockchain-based exchange of value can be completed quicker, safer and cheaper than with traditional system. A blockchain can assign title rights because, when properly set up to detail the exchange agreement, it provides a curated record that compels offer and acceptance. The use of an exchange network of expert-curated records containing legal diligence information for CRE assets is novel. Legal diligence information has not previously been systematically standardized and captured in a curated, meaning-laden way with corroborative materials, nor maintained in a time-stamped, encrypted medium, such as blockchain allows. This structure of the present disclosure offers substantial savings of reduced time, reduced cost, reduced execution uncertainty, and reduced risk/evaluation of actionable information for transaction participants.

The security of a blockchain is provided by two mathematically driven techniques combined in a novel way: public key encryption and secure hashing. The use of these techniques underscores the fundamental properties of the bitcoin network and blockchain functionality.

Public key (or asymmetric) encryption is a secure means of encrypting transactions which makes it (based on the computing time necessary) impossible to decrypt without the correct keys. Through a complex mathematical relationship (utilizing elliptical curves) a “private” encryption key can be chosen and a “public” key derived. Note: The private key cannot be derived from the public key. The relationship between the keys is such that whichever one is used to encrypt a message, the other is needed to decrypt the message.

This means a person in possession of a set of keys can publish the public key to allow counterparties to send him/her a message that only he/she can decrypt with the private key. In reverse, the owner of the keys can send a message, which is equivalent to a signature or proof of identity, by encrypting it with the private key. Anyone can decrypt that message with the sender's public key and know it must be valid as it can only come from a person who knows the private key. By this means, people can send secure messages to and from each other with their respective public keys and the only requisite for confidentiality is that the individuals do not disclose their individual, separate and unique private keys. This is in fact the technique used to encrypt and send email across the internet securely. Secure hashing is a complicated mathematical process of turning any piece of binary data into a finite-digit hexadecimal (i.e. base 16) number. For the current, published Secure Hashing Algorithm standard (SHA 256), the finite number of digits is 64. With 64 digits having anyone of 16 (i.e., 24) values (0-9 and a-f), there are 2256 (i.e., 2(4×64)) possible hashes. Note: The hashing process cannot be reversed to generate the original data. For more security, a hash can be made of a hash multiple times or hashed with further data.

What the final hash represents is a secure way of verifying original data. If you have the original data in binary form, you can recreate the same hash from the same technique. If you obtain a different hash, then the original data is incorrect or has been tampered with. This is the technique used for verifying passwords over the internet.

In order to securely record and transfer bitcoin without double spending, stealing, or forging of value, a process combining public encryption and secure hashing is used. With bitcoin, there is not the concept of a balance like a bank account. The distributed ledger has a record of the entire users' unspent transaction outputs (abbreviated as UXTO) from prior transactions. Each user (or technically the node on which they transact) has a copy of the distributed ledger so before accepting a transfer of bitcoin, the recipient can confirm the payer's UXTO. The confirmation of the payer (being who they say they are) is both through the public encryption of the transaction matching the payer's public key and the payer, optionally, being able to unlock the unspent value with an encrypted encumbrance. The cryptographically confirmed transaction creates a hash of the transaction data (including the reference to the ledger blocks which proved the UXTO) and is submitted to the transaction pool. At this point, the transaction is deemed contractually entered into but it is not able to be referenced until it is recorded on the blockchain ledger. In order to create a new block a group of transactions, up to 1 MB of memory have to be grouped and their collective data securely hashed referencing the prior blockchain block's hash. This then creates a new hash for the new block to be referenced by the next future block. In this way a chain of blocks is formed which sequentially reference each other according to the encrypted transaction content. “Proof of consensus” requires at least 51% or a defined, greater majority of the network to accept a new node before it is validated. Having created a new block, the node will start communicating it to other nodes, which will only accept it if the hashing matches the referenced blocks, the transaction details and the level of difficulty. However, if the new block meets the criteria, the nodes will accept the new block and communicate it to other nodes. So there is a period of dissemination of the new block to the network. Transactions not included in the new block rise in priority to be included in the next block to be created.

In summary, the blockchain is a peer-to-peer network-based, distributed, self-referencing, single-chain, single-record ledger for the purpose of recording transfers of value, including, for purposes of the present disclosure, information records. The ledger stores records from the very first transaction until the latest record. This means the distributed ledger, of which every network node has a copy, is a continuous and expanding record of all transactions. The control and integrity is maintained by: (1) all participants in a blockchain being able to reference prior blocks to prove their own or their counterparties unspent balances; (2) only the user with the unspent value being able to prove ownership through a digital signature that value to be spent; (3) the two parties agreeing to a transaction through public encryption and submitting a transaction to a pool to be processed referencing the prior blocks validating the unspent value; (4) a mechanism, such that the transactions are added in blocks to the single-chain, distributed ledger by referencing the prior block's hash and creating a new block with a new hash for the next block, which references the transactions in the block; (5) the integrity of each block's creation is maintained through various methods that include: competition, consensus or value held; (6) ultimately a majority of the other nodes have to accept any new block for it to be widely available; and (7) the new block forms part of the expanding immutable record to be referenced for future transactions.

Commercial mortgage-backed securities (CMBS) are a type of mortgage-backed security that is secured by mortgages on commercial properties. A CMBS can provide liquidity to real estate investors and commercial lenders. In a CMBS transaction, many single mortgage loans of diverse size, property type, and location are pooled together into a single security, and are sold as interests in that security.

Legal diligence for CMBS transactions is currently a highly particularized and fractionalized process that is limited in scope and ill-suited to risk-related data aggregation. The present disclosure delivers a system and method that aggregates actionable information for commercial real estate loan origination, warehouse or so-called repo financing, securitization or other secondary market activity and loan servicing. The present disclosure contemplates the creation of an information record containing various elements: a topically-organized data array capturing issue-context-mitigant information called a Legal Data Record (LDR), source material related to the asset and transaction, and counsel work product developed during the course of loan origination, securitization, or servicing. Those components contain attributes of a real estate asset that can be verified and added to a blockchain, where each blockchain is comprised of linked blocks or information records containing financial transactions or events involving a particular commercial real estate asset. The information contained in the information record is curated by a subject matter expert who assures the adequacy of the scope of data capture and corroborating material needed to conduct legal review and assessment of risks associated with the asset. In a CMBS transaction, the due diligence process involves a particular scope of information that is sufficient for the loan sellers to comfort extensive loan-level representations and warranties, satisfy securities law disclosure requirements, and diligence requirements of other transaction participants such as investors and rating agencies. From the lender's standpoint, the legal review and risk assessment must also assure compliance with applicable internal guidelines and regulatory requirements.

The LDR preferably includes information related to property owner, property ownership type, property type, address, closing date, loan amount, borrower's structure, additional debt information, transaction structure, collateral, property condition, ongoing proceedings, sponsor issues, permitted property or equity transfers, borrower/guarantor information, SPE characteristics, recourse liability information, information on the loan note, prepayment terms, property insurance information, encumbrance information, cross-default or cross-collateralization information, escrow information, title policy and survey information, UCC information, zoning and local law compliance, tenant information or lease issues, ground lease information, and other important information.

A loan origination counsel collects information required in a Legal Data Record (LDR) template. The template may be an electronic questionnaire or form that can be used to solicit and retain information associated with the real estate asset and contemplated transaction. The template may be presented (e.g., displayed) to the user via a web portal. The LDR acts as a roadmap for the broad information capture at loan origination. It also provides an organizing framework for additional securitization information that will be incorporated into the information record published to the Blockchain (the “LIMB Record”), where LIMB stands for “Legal Information Managed Blockchain.” The LDR organizes loan and underlying asset information by topic, with questions that elicit the identification of material legal issues, including factual context and mitigating information. The topic headings include information about general attributes; the borrower and guarantor information; recourse liability attributes; note terms; prepayment or call protection terms; mortgage and other loan document provisions; cross-default/cross-collateralization; additional debt; escrows and cash management features; title policy, survey, and UCC attributes; zoning and local law compliance matters; various special issues; lease information, including ground leases; loan underwriting process and credit matters; and environmental matters. The legal review information database can be queried by lender stakeholders, including in-house counsel, parties connected to the loan closing process or loan program management for various purposes: (i) best practices information, (ii) legacy practices related to legal issue responses; and (iii) correlation to other loan information. Subject to extent of access rights that are granted, users will have permission to specific parts of database. Information report templates will be customized for specific user groups and access rights as well as for specific deliverables such as rep exceptions, the due diligence questionnaire responses, rating agency query responses or investor information schedules. Further, information report templates will be customized for subsequent transactions or activities, such as loan seller, servicing on-boarding processes and servicing consent transactions.

Information in the LDR database together with source document and work product attachments are incorporated into the blockchain. The LIMB Record will also include, to the extent available or applicable, loan origination, securitization or servicing information prepared about the real estate asset, attachments for relevant source documents or other counsel work product. For the user, this can be visualized by a “right-side-up” pyramid: the summary information is at the top, and supporting source information and analysis is available to drill-down.

Chronologically, the closing counsel prepares LDR when loan closes, and provides other source documents and work product that become part of legal review file. Loan seller counsel then reviews the legal review file and provides comments to LDR if necessary (such that corrected LDR forthcoming) and otherwise extracts information germane to that loan for the related loan pool securitization. At closing, loan sellers' counsel provides a so-called “10b-5” or negative assurance letter concerning material misstatements of fact or omissions of material facts. Once loan seller counsel's legal review function is completed (including loan disclosure, exceptions to the seller's representation and warranties concerning the mortgage loans, responses to rating agencies and investor questions, loan servicing-related functions, and takeaways), then database information and source document and work product attachments can be finalized and incorporated into a new block for that asset. The database includes information derived from the LDR's data array for all loans for a particular user (e.g., a bank or financial institution). The source document and work product attachments are not part of the database, but can be accessed through the asset-level blockchain. The blockchain includes the asset-level block (which includes database information and source documents/work product attachments) created for an initial event associated with the asset, together with additional blocks for subsequent servicing-related events or asset-related transactions forming a blockchain. The later events in that asset's life cycle can include a property or equity ownership transfer, subsequent refinancing or acquisition financing, warehouse or repo lending, loan sale or subsequent securitization or other capital markets transactions like commercial real estate collateralized loan obligations (CRE CLO's).

For any later event involving an asset with a LIMB Record, the related lender can reduce diligence costs and overall transaction time for the transaction, because the later-event legal diligence can be limited to bring-to-date diligence and corroborating the accuracy of the underlying record. Put differently, a subsequent user can piggy-back on the prior information and analysis, rather than incurring the search cost and time of discovering relevant legal information from scratch. The LIMB Record is a benefit to transaction parties in loan servicing consent transactions, such as assumptions, lease or encumbrance permissions by expediting underlying property diligence reducing cost and the uncertainty of executing the related transaction, as well as transmitting the curated narrative concerning material issues related to the asset. The LIMB Record is a benefit to lenders by creating a useful touchpoint with its borrowers, both in the sense of giving borrower access to legal review information it can use later and encouraging communication around asset update events. Owners can self-report events like leasing, so that the LIMB Record stays updated between major events. The lender-borrower dynamic can move from one-off/transactional to iterative/relational in nature, benefiting both sides.

The later events in that asset's life cycle can include a property or equity ownership transfer, subsequent refinancing or acquisition financing, warehouse or repo lending, loan sale, or subsequent securitization or other capital markets transactions like commercial real estate collateralized loan obligations (CRE CLO's). The LIMB Record is a document management, document validation, and organizational for later-event transactions, which itself saves valuable time and cost. For any later event involving an asset with a LIMB Record, the related lender can reduce diligence costs and overall transaction time for the transaction, because the later-event legal diligence can be limited to bring-to-date diligence and corroborating the accuracy of the underlying record. Further, the costs related to validating intermediaries such as document custodians can be reduced or eliminated.

The LDR database includes report templates such as a broadest-scope report from the material derived from the LDR, various reports can be created for Lenders' counsel and other transaction stakeholders that aligns with expected deliverables. Lenders and counsel can control access rights to their respective sub-users or third parties, and can control or shape report content to address confidentiality or data privacy concerns.

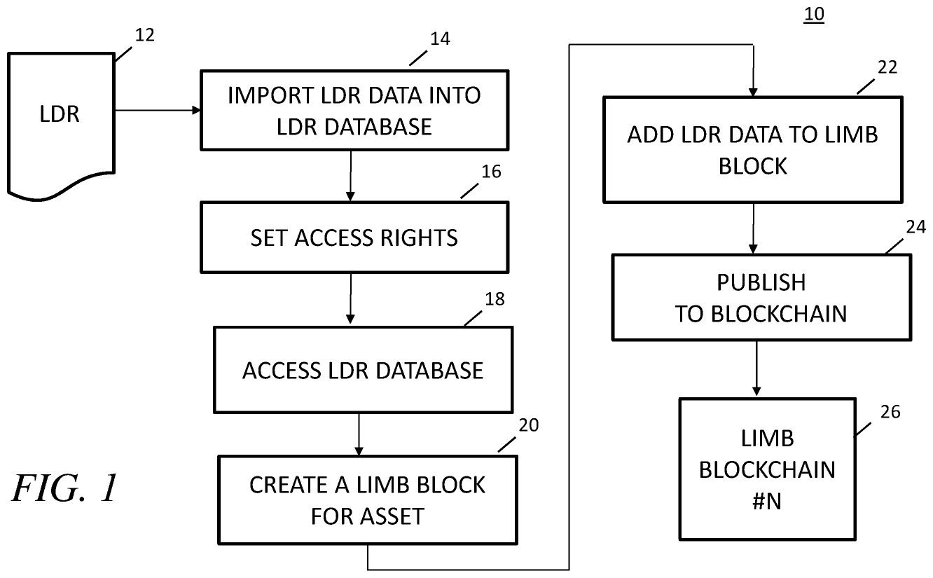

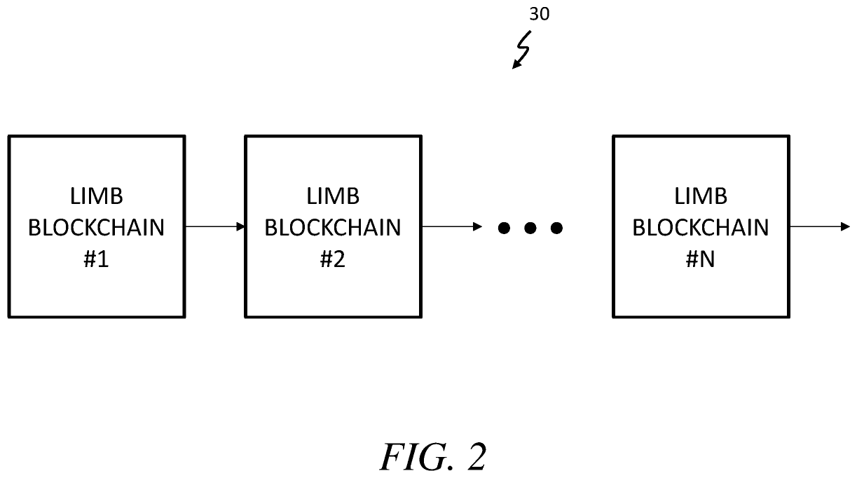

Referring to FIG. 1 for a simplified flowchart of an exemplary embodiment of the CMBS legal review process 10 according to the teachings of the present disclosure, closing counsel uploads or imports LDR data 12 into a database 14. The access rights to the data can be set to enable all or different subsets of the data to be accessible by the loan seller's counsel and others 16. The loan seller's counsel may access the information in the database to conduct legal review and risk assessment 18. At the conclusion of the transaction, the information in the LDR and the attendant source documents and curated work product is reviewed for compliance with publishing protocol and, if approved, the data are aggregated in the LIMB Record and published to the blockchain 30 created for that asset (20-26), as shown in FIG. 2. The block thus holds information related to the CMBS or other financing-related transactions that is hashed and encoded into a Merkle tree. The block includes the cryptographic hash of the prior block in the blockchain, linking the two blocks to form a chain. This iterative process confirms the integrity of the previous block, all the way back to the original genesis block. In subsequent transactions, the legal review process is much more efficient as the legal counsel may access and review existing data in the blockchain and only update the information since the last transaction documented in the blockchain.

The blockchain technology is secure, immutable, compatible, connectable and has effectively limitless capacity. It is ideal for storing an information record from one event in the life cycle of a real estate asset to another. The blockchain provides other adaptive uses once meaningful data has been compiled, including workflow actions across a network of users and smart contract applications. Using blockchain technology, all participants in a blockchain for an asset must agree to the validity of a transaction, all participants have access to information that verifies the provenance of the asset, and no single participant can tamper with a transaction after it has been recorded to the ledger.

Because the scope of the LDR information is curated around materiality principles and includes in summary fashion the information and analysis supporting materiality conclusions, it is “standard-setting” and “meaning-gathering.” For users conversant with commercial real estate transactions, this saves time and cost by (i) identifying high-value information and limiting the need for successive information requests; and (ii) reducing low-value information-gathering. Legal review costs are otherwise expensive and time-consuming.

The Blockchain Record facilitates transactional activity related to the underlying asset, because it contains actionable material information that would otherwise be costly and time-consuming to create de novo from available source material or available experts. By aggregating LIMB Records from multiple lenders, and combining transaction-facilitating forms and checklists, secondary market trading of loans can be accelerated with less information asymmetry and related risks.

The LIMB Record has an allocative effect: it signals what capital markets legal information requirements and acceptable outcomes look like. De-mystifying that can help users plan more effectively for early stage assets (i.e., raw land, land under development, or transitional properties where cash flows are not fully stabilized) so that legal review information can be built to best ultimate effect as the asset goes through its life cycle.

Property and mortgage brokers benefit from the LIMB Record: providing right-sized and actionable information records pre-empts what counterparties would be concerned about, and reduces the marketing time/cost of finding the right counterparty, as well as reducing the scope of necessary diligence time or feasibility periods. Transaction friction created by gaming behavior is reduced, with greater certainty of execution. Especially in a purchase and sale context, where risk-related information directly impacts the negotiated price and risk allocation can be positively influenced by validated, timely and properly-scoped diligence information, the LIMB Record impact can be dramatic.

The idea is focused on legal review information related to commercial real estate (CRE) loans, as distinguished from (i) loan origination or loan underwriting information typically compiled by lenders in the process of originating CRE loans (i.e., no credit analysis or property cash flow analysis); and (ii) residential mortgage loans, which are typically originated and underwritten based on borrower income-based metrics (i.e., debt-to-income ratios).

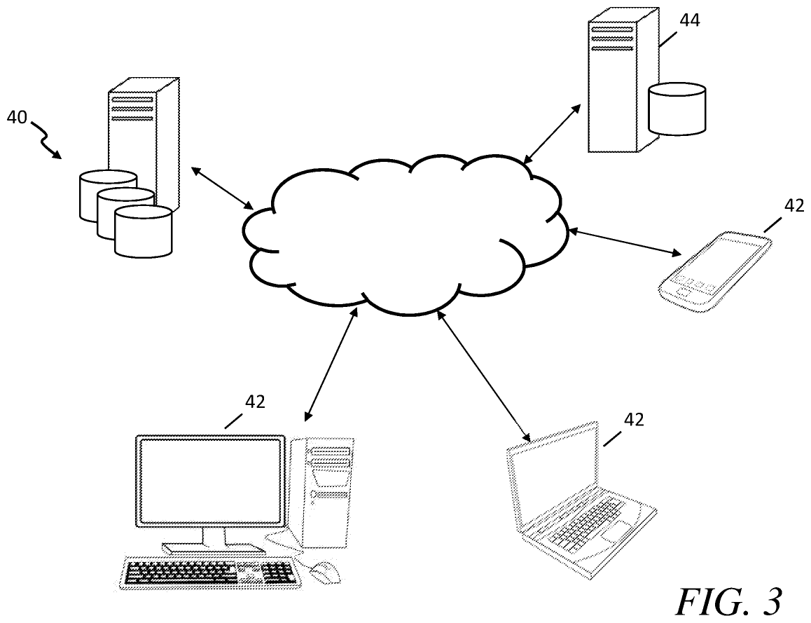

Referring to FIG. 3, the LIMB database 40 is accessible via one or more nodes of the Internet by a variety of computers and devices 42, including desktop computers, laptops, tablet computers, mobile phones, and other types of computing devices. A lender web portal, legal counsel web portal, and administrator's web portal may be hosted on one or more web servers 44 and facilitate access by users. The blockchain is decentralized and distributed, thus stored in a plurality of network nodes. The blockchain is a digital ledger that is used to record the CMBS transactions across many computers so that the record cannot be altered retroactively without the alteration of all subsequent blocks and the consensus of the network. Further, the blockchain is a public/private permissioned ledger that participants and access are constrained by a set of policies. The permission policies established by the lender govern who can access the data stored in the blockchain and which subset of data can be accessed by whom. In this manner, a national network of blockchains consisting of LIMB (Legal Information Managed Blockchain) records can be developed that are accessible to participants constrained to the permission policies. Blockchains are connectable, such that users can establish a network to transfer BRLIs within permissioning protocols for any asset covered by a user's aggregation of blockchain records. LIMB establishes a data capture standard (satisfying service mission and borrower experience goals) for light transitional-to-stabilized CRE assets, using CMBS as an evaluative paradigm. Each lender within the LIMB network has the ability to publish to the blockchain unilaterally after agreed protocols have been followed. Each lender is assigned a private key that is necessary to publish or transfer LIMB information records. The transfer of LIMB information records is effected through an exchange network comprised of lender and other participants.

The present system and method are capable of aggregating loan origination, warehouse finance, securitization, and servicing-relevant data for increased functionality and additional processing using Artificial Intelligence and/or Machine Learning applications. The present system and method break down CMBS legal due diligence issues into “issue-mitigant-context”-related data points that can then be aggregated for risk tolerance and decisional evaluation. Other legal review methods are narrative-driven and not susceptible to aggregation and categorization. Properly compartmentalized data can then be mined AI applications that evaluate systematic risk, pricing of that risk, and the behaviors associated with it.

A summary of the proposed LIMB process applicable to loan origination and securitization-related review is set forth below:

Step 1: Origination Counsel (OC) completes the LDR in conjunction with closing the loan. There can be internal steps that OC uses before the LDR is completed and send-off to Loan Seller Counsel (LSC). The OC can assign sub-user authorization levels that match preparation-to-approval responsibilities among the OC's sub-users.

Step 2: When OC deems LDR to be complete, it sends-off to LSC as part of securitization review process.

Step 3: LSC reviews the submitted LDR Part A from the OC (as well as the submitted, lender-prepared Part B covering origination/underwriting information) in addition to other loan documents, property diligence materials, lender-created loan reports and the accounting tape (the “Origination Deliverables”). A by-product of LSC review is a curative e-mail, which identifies open issues for follow up and corrective action where necessary. An element of the curative e-mail is comments pertaining to LDR. In a substantial number of loan reviews, there is some revision to LDR that is required. If revisions are required, the OC will re-submit the corrected LDR Part A to LSC and LDR Part B to the lender.

Step 4: The LDR is now final (having been approved by LSC), and can be included as part of the Information Record for the loan when published to the blockchain. For now, these parts are just held in-place pending completion of the securitization.

Step 5: Other parts of the Origination Deliverables can also be added to the Information Record for the loan when published to blockchain, including final executed loan documents, closing instructions letter with approved title pro forma, insurance review, lender reports (Asset Summary Report), and accounting tape line for the loan/property.

Step 6: LSC generates the securitization-related legal review deliverables (“Securitization Deliverables), including Rep Exceptions, Due Diligence Questionnaire (DDQ) responses that map to loan-level disclosure, Rating Agency Query (RAQ's) responses to prescribed loan issues (if applicable), and Free Writing Prospectus (FWP) Inserts that capture the loan-level narrative disclosure that is included in the required securities filing. Each of these deliverables has a corresponding report format that can be pre-populated from the approved LDR and its database.

Step 7: As securitization is completed, LSC compiles the remaining loan-level information from the pool-level disclosure: effectively sorting the pertinent pool-level information into loan-level buckets.

Step 8: LSC completes LDR Part C, which includes securitization party information.

Step 9: LSC compiles Information Record (with Origination Deliverables and Securitization Deliverables) for each individual loan in the securitized loan pool.

Step 10: LSC coordinates with Lender to publish the complete, approved Information Record to the blockchain.

For warehouse financing transactions, which involve the warehouse lender's providing financing to the loan originator, the scope of actionable data capture is substantially subsumed by the scope of data capture related to the securitization. Currently the loan review process for the warehouse lending and securitization functions are not coordinated. The LIMB Record for an asset could substantially suffice for the warehouse finance-related review, and reduce attendant cost, time, uncertainty of execution and information asymmetry.

For servicing consent transactions, the LIMB Record serves as a validated snapshot of the asset at the point in time of the last event. Applying the loan documents, the servicer can use the LIMB Record to reduce the scope of bring-to-date diligence and reduce the time and cost of obtaining, organizing and understanding documents related to the underlying asset in its transactional content.

The features of the present invention which are believed to be novel are set forth below with particularity in the appended claims. However, modifications, variations, and changes to the exemplary embodiments of the system and method described above will be apparent to those skilled in the art, and the system and method described herein thus encompasses such modifications, variations, and changes and are not limited to the specific embodiments described herein.

### Glossary

CMBS—Commercial Mortgage-Backed Securities

CRE—Commercial Real Estate

LDR—Legal Data Record

LIMB—Legal Information Managed Blockchain

LSC—Loan Seller Counsel

OC—Origination Counsel

What is claimed is:

1. A computerized method for maintaining legal due diligence information associated with a real estate asset comprising:
providing a legal data record template for receiving information related to the real estate asset;
storing the legal data record information in a database;
setting access rules for accessing the legal data record information in the database;
creating a blockchain record of legal information that contains the legal data record information from the database;
adding the blockchain record of legal information to a blockchain for the real estate asset;
maintaining the blockchain for the real estate asset; and
creating a network of connected blockchains that are accessible to participants according to permission protocols.

2. The computerized method of claim 1, wherein providing a legal data record template for receiving information comprises receiving a curated set of material information related to the real estate asset.

3. The computerized method of claim 1, wherein providing a legal data record template for receiving information comprises receiving a curated set of material information related to property owner, property ownership type, property type, address, closing date, loan amount, borrower's structure, additional debt information, transaction structure, collateral, property condition, ongoing proceedings, sponsor issues, permitted property or equity transfers, borrower/guarantor information, SPE characteristics, recourse liability, loan note, prepayment terms, property insurance, encumbrance, cross-default or cross-collateralization, escrow, title policy and survey, UCC, zoning and local law compliance, tenant or lease issues, and ground lease.

4. The computerized method of claim 1, wherein providing a legal data record template for receiving information comprises receiving a curated set of material information related to the borrower and guarantor information; recourse liability attributes; note terms; prepayment or call protection terms; mortgage and other loan document provisions; cross-default/cross-collateralization; additional debt; escrows and cash management features; title policy, survey, and UCC attributes; zoning and local law compliance matters; various special issues; lease information; loan underwriting process; credit matters; and environmental matters.

5. The computerized method of claim 1, wherein providing a legal data record template for receiving information comprises presenting an electronic questionnaire via a web portal.

6. The computerized method of claim 1, wherein providing a legal data record template for receiving information comprises presenting an electronic form via a web portal.

7. The computerized method of claim 1, wherein creating a blockchain record comprises creating a blockchain record that contains asset-level information, source documents, and legal counsel work product.

8. The computerized method of claim 1, further comprising providing access to the blockchain record according to permission protocols.

9. The computerized method of claim 1, further comprising accepting a new blockchain record containing later-event information related to the real estate asset to the existing blockchain.

10. The computerized method of claim 1, further comprising generating and providing reports containing data in the legal data record.

11. A computerized method for conducting legal due diligence for a commercial real estate asset in a commercial mortgage-backed security transaction comprising:
accessing information related to the commercial real estate asset stored in an existing blockchain for the commercial real estate asset according to access policies;
providing a legal data record template for receiving updating information related to the commercial real estate asset;
storing the legal data record information in a database;
setting access rules for accessing the legal data record information;
creating a new blockchain record of legal information that contains the legal data record information from the database;
adding the new blockchain record of legal information to the existing blockchain;
maintaining the blockchain for the commercial real estate asset; and
creating a network of connected blockchains that are accessible to participants according to permission policies.

12. The computerized method of claim 11, wherein providing a legal data record template for receiving information comprises receiving a curated set of material information related to the real estate asset.

13. The computerized method of claim 11, wherein providing a legal data record template for receiving information comprises receiving a curated set of material information related to property owner, property ownership type, property type, address, closing date, loan amount, borrower's structure, additional debt information, transaction structure, collateral, property condition, ongoing proceedings, sponsor issues, permitted property or equity transfers, borrower/guarantor information, SPE characteristics, recourse liability, loan note, prepayment terms, property insurance, encumbrance, cross-default or cross-collateralization, escrow, title policy and survey, UCC, zoning and local law compliance, tenant or lease issues, and ground lease.

14. The computerized method of claim 11, wherein providing a legal data record template for receiving information comprises receiving a curated set of material information related to the borrower and guarantor information; recourse liability attributes; note terms; prepayment or call protection terms; mortgage and other loan document provisions; cross-default/cross-collateralization; additional debt; escrows and cash management features; title policy, survey, and UCC attributes; zoning and local law compliance matters; various special issues; lease information; loan underwriting process; credit matters; and environmental matters.

15. The computerized method of claim 11, wherein providing a legal data record template for receiving information comprises presenting an electronic questionnaire via a web portal.

16. The computerized method of claim 11, wherein providing a legal data record template for receiving information comprises presenting an electronic form via a web portal.

17. The computerized method of claim 11, wherein creating a blockchain record comprises creating a blockchain record that contains asset-level information, source documents, and legal counsel work product.

18. The computerized method of claim 11, further comprising providing access to the blockchain record according to permission protocols.

19. The computerized method of claim 11, further comprising accepting a new blockchain record containing later-event information related to the real estate asset to the existing blockchain.

20. The computerized method of claim 11, further comprising generating and providing reports containing data in the legal data record.

21. A system of facilitating legal due diligence for a commercial real estate asset in a commercial mortgage-backed security transaction comprising:
a database;
providing a web portal configured to enable:
accessing information related to the commercial real estate asset stored in an existing blockchain for the commercial real estate asset according to access policies for the blockchain;
providing a legal data record template for receiving updating information related to the commercial real estate asset; and
storing the legal data record information in the database; and
logic for:
creating a new blockchain record of legal information that contains the legal data record information from the database;
adding the new blockchain record of legal information to the existing blockchain;
maintaining the blockchain for the commercial real estate asset; and
creating a network of connected blockchains that are accessible to participants according to permission policies.
